(19) United States
(12) Patent Application Publication
(10) Pub. No.: US 2019/0120765 A1
(43) Pub. Date: Apr. 25, 2019

(54) BACKSCATTER FLUORESCENCE DETECTION OF FLUIDS

(71) Applicant: ExxonMobil Research and Engineering Company, Annandale, NJ (US)

(72) Inventors: Christopher VANDER NEUT, Spring, TX (US); Michael L. ALESSI, Rose Valley, PA (US)

(21) Appl. No.: 16/137,954

(22) Filed: Sep. 21, 2018

Related U.S. Application Data
(60) Provisional application No. 62/574,439, filed on Oct. 19, 2017.

(51) Int. Cl. G01N 21/64; G01N 21/47

(52) U.S. Cl. CPC G01N 21/64; G01N 2021/4709; G01N 21/47

(57) ABSTRACT

Systems and methods are provided for in-situ characterization of a working fluid based on fluorescent backscattering. Instead of attempting to transmit light through the working fluid, backscattered fluorescent light generated by the working fluid and/or by a fluorescent marker in the working fluid can then be detected. Thus, fluorescence can be induced in or near a surface layer of the fluid relative to the housing containing a light source, and the resulting fluorescence can be detected by a detector located in the same housing or an adjacent housing. By avoiding the need to transmit light through the liquid, difficulties with absorption and/or scattering due to particles, soot, or other debris in the working fluid can be reduced or minimized. This can allow detection of the fluorescence to be maintained as a working fluid ages.

### CROSS-REFERENCE TO RELATED APPLICATIONS

This application claims the benefit of U.S. Provisional Application No. 62/574,439, filed on Oct. 19, 2017, the entire contents of which are incorporated herein by reference.

### FIELD

This invention relates to systems and methods for in-situ characterization of a fluid using fluorescent backscattering.

### BACKGROUND

A wide variety of analysis methods are available for characterizing a working fluid, such as a lubricant in an engine environment or other lubricating environment. Unfortunately, conventional analysis methods often have one or more limitations which can limit the utility of the characterization method. For example, some characterization methods are not suitable for in-situ characterization of a working fluid. Instead, such characterization methods can require withdrawal of a sample of the working fluid from the working fluid environment prior to characterization. As another example, some characterization methods are suitable for characterization of a “clean” version of a working fluid, but can have difficulties as the working fluid changes over time.

Fluorescence is an example of a spectroscopic method that can be used for characterization of a working fluid. Some conventional fluorescence methods include adding a specific fluorescent compound or dye to a working fluid to facilitate characterization. U.S. Pat. No. 8,906,698 describes methods for measuring fluorescence in liquids where a fluorescent marker is added to the liquid. The methods include modifying the conditions of the liquid to quench the fluorescence in order to determine how absorbance and/or fluorescence of the bulk liquid may impact the fluorescence behavior of the fluorescent marker.

### SUMMARY

In various aspects, a fluorescent backscattering system is provided. The system can include a housing comprising a housing volume. The housing volume can include a first surface that is at least partially transparent to a first set of wavelengths and a second surface that is at least partially transparent to a second set of wavelengths. Optionally, the first surface and the second surface can correspond to the same surface. The system can further include a light source (optionally mounted) within the housing volume. The light source can be capable of generating light comprising at least one wavelength of the first set of wavelengths. The system can further include a light collector (optionally mounted) within the housing volume. The light collector can include a receiving surface. The receiving surface can be optically aligned with the second surface. This can, for example, allow fluorescent light generated by a working fluid and/or a fluorescent marker to pass through the second surface and be received by the receiving surface of the light collector. The system can further include a sensor for receiving light collected by the light collector. Optionally, the sensor can include the light collector. Optionally, the light collector can correspond to a fiber optic collector in communication with the sensor, with the receiving surface corresponding to a surface of the fiber optic collector. A fiber optic cable is an example of a fiber optic collector. Optionally, the system can further include a signal analyzer for receiving one or more values from the sensor and performing a comparison based on the received values with at least one reference value.

In some configurations, the housing can be mounted in a volume of a working fluid environment. In such configurations, the housing can form part of an interior surface of the working fluid environment for containing any fluids in the volume of the working fluid environment.

In some aspects, the sensor can correspond to an RGB color sensor. In some aspects, the light source can correspond to at least one of an ultraviolet light source, a visible light source, and an infrared light source. In some aspects, at least one of the first set of wavelengths and the second set of wavelengths comprise ultraviolet wavelengths, visible wavelengths, infrared wavelengths, or a combination thereof. For example, the first set of wavelengths can correspond to ultraviolet wavelengths and/or visible wavelengths while the second set of wavelengths correspond to visible wavelengths.

In various aspects, a method for characterizing a working fluid using fluorescent backscattering is provided. The method can include passing a working fluid through a volume of a working fluid environment. Optionally, optionally the working fluid can include 1 wppm to 1000 wppm, such as 5 wppm to 30 wppm, of a fluorescent marker. The volume of the working fluid environment can include a first surface that is at least partially transparent to a first set of wavelengths and a second surface that is at least partially transparent to a second set of wavelengths. Optionally, the first surface and the second surface can correspond to the same surface. Optionally, the first surface and the second surface can be separated by 1.0 cm or less. At least one of the working fluid and the fluorescent marker can have a fluorescent transition capable of being excited by one or more wavelengths of the first set of wavelengths. After excitation, the at least one of the working fluid and the fluorescent marker can generate fluorescent light comprising at least one wavelength of the second set of wavelengths. As the working fluid is passed through the volume of the working fluid environment, light can be generated comprising at least one wavelength of the first set of wavelengths. At least a portion of the generated light can being incident on the first surface. This can allow, for example, excitation of the fluorescent transition of the at least one of the working fluid and the fluorescent marker. The resulting fluorescent light generated based on the excitation can then be received through the second surface, such as receiving by a receiving surface of an optical fiber collector. Optionally, both the working fluid and the fluorescent marker can have a fluorescent transition.

In some aspects, the method can further include characterizing the received fluorescent light, such as by comparing at least one value determined based on the received fluorescent light with a reference value. As an example, in aspects where the sensor corresponds to an RGB color sensor, the received fluorescent light can contribute to generation of three intensity values corresponding to red, green, and blue channels. One or more of these channels could be compared with a reference value and/or the channels can be used to calculate a characteristic value that can then be compared with a reference value.

In some aspects, the working fluid can correspond to a lubricating oil, a hydraulic fluid, a brake fluid, a fuel, a grease, a transmission oil, an engine oil, a gear oil, or a combination thereof; or a combination thereof. In some aspects, the working fluid can include 0.1 vol % to 7.0 vol % of soot, particles, debris, or a combination thereof. Such soot, particles, and/or debris can be present, for example, due to aging of the working fluid.

### BRIEF DESCRIPTION OF THE FIGURES

FIG. 1 shows an example of a configuration for a fluorescent source and backscatter detector.

FIG. 2 shows results from characterization of a working fluid using fluorescent backscatter both with and without addition of a fluorescent dye.

FIG. 3 shows results from characterization of a working fluid using fluorescence spectroscopy configured for transmission of light through the working fluid.

### DETAILED DESCRIPTION OF THE EMBODIMENTS

### Overview

In various aspects, systems and methods are provided for in-situ characterization of a working fluid based on fluorescent backscattering. Instead of attempting to transmit light through the working fluid, a fluorescent marker can be added to the working fluid in a sufficient amount of allow for absorption of incident light near the fluid surface. The resulting fluorescence caused by absorption of incident light by the marker can then be detected using a detector in a backscatter configuration (i.e., using a detector located in the vicinity of the light source). Thus, fluorescence can be induced in or near a surface layer of the fluid relative to the housing containing a light source, and the resulting fluorescence can be detected by a detector located in the same housing or an adjacent housing. By avoiding the need to transmit light through the liquid, difficulties with absorption and/or scattering due to particles, soot, or other debris in the working fluid can be reduced or minimized. This can allow detection of the fluorescent marker to be maintained as a working fluid ages, so long as the fluorescent marker remains present in the working fluid at a sufficient concentration.

Additionally or alternately, in various aspects, systems and methods are provided for in-situ characterization of the age of a working fluid using fluorescent backscattering. In addition to fluorescence based on absorption of light by a fluorescent marker, many types of working fluids also include components that can fluoresce. In such aspects, the fluorescence from components of a working fluid can also be detected. Any changes in the fluorescence of the working fluid can be correlated with changes in the nature of the working fluid, including the presence of contaminants and/or the loss or conversion of the fluorescent compounds in the working fluid. After developing suitable correlations, the correlations can be used to determine an age or quality for a working fluid based on the change in the fluorescence.

One of the difficulties with using spectroscopic techniques for characterization of working fluids is the conventional limitation that such techniques are suitable for “clean” fluids, but not effective for working fluids that have been modified during use. A variety of possibly modifications can occur for a working fluid during use in a working fluid environment. Possible modifications include, but are not limited to, changes in the composition of the working fluid due to degradation of compounds in the working fluid; introduction of particles into the fluid due to wear in the working fluid environment and/or precipitation of solids; introduction of combustion products and/or soot into the working fluid; and introduction of other contaminants into the working fluid. Such modifications of a working fluid during use can pose difficulties for traditional spectroscopic methods, resulting in reduced or minimized ability to perform spectroscopic characterization.

An example of degradation of a working fluid in a working fluid environment can correspond to the buildup of soot in a lubricating oil in an engine environment. During operation of an engine, soot from the combustion process in the engine can be transferred into the lubricant oil. As little as 0.1 vol % (or possibly less) of soot in the lubricating oil can potentially cause difficulties when attempting to transmit light through the lubricating oil to perform spectroscopy. The difficulties may be due to light adsorption, light scattering, and/or other problems with light transmission in a fluid containing heterogeneous particles. More generally, depending on the nature of the lubricating oil, it may be desirable to operate an engine environment with 0.1 vol % to 7.0 vol % (or 0.1 vol % to 6.0 vol %) of soot within the lubricating oil prior to changing the oil.

It has been unexpectedly discovered that the problems with spectroscopic characterization of working fluids can be overcome by using fluorescent backscattering to characterize a fluid. Without being bound by any particular theory, it is believed that the difficulties for conventional spectroscopic techniques can be related to transmission and/or scattering losses when attempting to pass light into or through an aged working fluid that has been modified (such as modified by particles, soot, or other contaminants). Fluorescent backscattering can overcome these difficulties due to the nature of the fluorescent backscattering technique. By introducing a fluorescent marker into a working fluid, sufficient absorption of light to cause fluorescence can occur near the interface between a housing for a light source and a surrounding working fluid. This ability to induce fluorescence in a surface layer near the light source can reduce or minimize losses due to transmission of light from the light source into the working fluid. Additionally, by using a backscatter detection method, the need to transmit a signal through the full path length of the working fluid can be avoided. Instead, fluorescence can be induced in a surface layer near the light source, and a co-located detector can then detect the fluorescence. By avoiding the need to transmit a signal into and/or through the working fluid, backscatter fluorescence can provide a characterization method that is suitable for characterization of new or clean working fluids as well as aged working fluids. Any convenient amount of a fluorescent marker can be used, such as 1 wppm to 1000 wppm, or 1 wppm to 500 ppm, or 1 wppm to 100 ppm, or 5 wppm to 30 wppm relative to a weight of the working fluid. Examples of suitable fluorescent markers include dyes, colorants, polyaromatic hydrocarbons, quinones, benziobenasphaltenes, benzothiazoles, detergents, ionic liquids, metallic nanoparticles, semi-conductor nanoparticles, fluorescent compounds, enzymes, DNA, RNA, polypeptides, fat soluble molecules with specific biological activity, redox-active organometallic complexes and array of molecules with unique molecular weight distributions

During either fluid manufacture or operation or a working fluid environment, a fluorescent marker can be added to a working fluid in a suitable amount. The working fluid can then be introduced into a working fluid environment. The working fluid environment can include a location where a light source and a fiber optic detector are contained within a housing or enclosure. The housing can have a transparent end to allow for transmission of light from the light source into the fluid and transmission of backscattered fluorescent light from the working fluid into the housing. A light collector within the housing can be used to collect fluorescent light transmitted into the housing for detection by an appropriate detector. The light collector can correspond to a light receiving surface of a sensor, a light receiving surface of a fiber optic collector that is connected to the sensor, or any other type of light collector that can provide collected light to a sensor. The light source and/or the fluorescent emissions from the working fluid can correspond to any convenient wavelengths. For example, the light source can correspond to an ultraviolet light source while the light emitted by the marker during fluorescence can correspond to visible light. Preferably, the wavelengths for the light source and the fluorescent emission can be sufficiently different to avoid difficulties in detecting the backscattered fluorescent emissions. An example of a suitable detector can be a red-green-blue (RGB) color sensor. This can allow for detection of an average color of backscattered fluorescent light without requiring a determination of total intensity.

Use of a fluorescent marker or dye can also simplify the characterization of the working fluid. For example, it can be desirable to characterize a fluid to determine whether the working fluid corresponds to a fluid designed for use in the working environment, or whether the working fluid is an imitation or counterfeit fluid. In this type of situation, detecting the presence or absence of a target fluorescent wavelength can be sufficient to characterize the working fluid. Additionally or alternately, detection of one or more color intensities, such as the color intensities produced by an RGB sensor, can be sufficient for identification of fluorescence from a fluorescent marker. Because only simple detectors are needed for detection of fluorescence, a fiber optic strand or cable can be a suitable collector for detection of fluorescent light. This can allow the collector to readily fit into the same housing as a light source for inducing the fluorescence. This can be in contrast to conventional fluorescence detectors, which are typically designed to have higher sensitivity detection of fluorescence in order to provide additional quantitative information regarding an amount or intensity of fluorescence.

In aspects where a sensor is used that provides multiple channels of intensity, such as an RGB sensor, it can be beneficial to combine the plurality of intensity values to form a single characteristic value. Any convenient type of combination can be used. The intensity values can be combined in a polynomial form, in an exponential and/or logarithmic form, in the form of addition-subtraction and/or multiplication-division of the channel values, or any convenient combination of the above types of forms. In some aspects, a characteristic value can be formed as a linear combination of channel values. For example, the relative outputs from an RGB sensor, called R, G, and B, may be added together (R+G+B) to give a characteristic value. Additionally or alternately, these outputs may also be compared via ratio, such as (R/G versus G/B). Additionally or alternately, these outputs may also be combined through other forms, such as (Ĝ2/(B*R)) or (100*B/(G*R)). Numerous other mathematical combinations may be used in order to determine whether a signal is different from a reference signal.

In addition to detection of the presence or absence of a fluorescent marker, in some aspects the fluorescent backscatter systems and methods described herein can be suitable for characterizing the relative age of a working fluid. For some types of working fluids, the modifications of the working fluid during use can follow a predictable pattern. Such a pattern can correspond to, for example, a change in an average color emitted via fluorescence by the working fluid. Reference colors or other reference patterns can be stored and compared with measured fluorescence values for the working fluid during use in order to determine an age and/or degradation state for the working fluid. In this type of aspect, fluorescence information can be used to determine the relative rate of aging of a working fluid. This can allow, for example, for determination of when maintenance needs to be performed on the working fluid environment and/or determination of when the working fluid needs to be changed.

It is noted that a portion of the color change detected in a working fluid can be due to color change associated with the working fluid that is not due to fluorescence. For example, as a working fluid ages and accumulates soot and/or other color bodies, the surface reflectivity properties of the working fluid may change. This can cause a change in the color of light reflected from the surface of the working fluid. In some aspects, the functional form of the characteristic value can be used to reduce or minimize the impact of non-fluorescent color changes from the working fluid on the characteristic value. For example, if the fluorescence of the working fluid and/or the fluorescence of a fluorescent dye corresponds to light that is primarily detected by the green channel of an RGB detector, the functional form can include a weight constant to increase the value of the green channel, or the functional form can include an exponent for the green channel, or any other convenient type of functional form can be used that can emphasize contributions from the color channel that is expected to correspond to a majority of the received fluorescent light.

In this discussion, a working fluid can correspond to any convenient type of fluid that may be present in an engine and/or machine environment. Examples of working fluids can include, but are not limited to, lubricants, hydraulic fluids, transmission fluids, brake fluids, fuels, greases, circulating oils, and gear oils. In this discussion, a lubricant can refer to a non-polar hydrocarbon fluid, hydrocarbon-like fluid, and/or synthetic fluid that is used within a working fluid environment to provide lubrication. This can include, for example, lubricants from the various types of categories as classified by the American Petroleum Institute (API). Such lubricants can include API Group I-III lubricants (mineral base stocks), API Group IV lubricants (polyalphaolefins), and various other types of lubricants such as ester-based fluids that are categorized as API Group V lubricants. In some aspects, a working fluid environment can correspond to a turbine, such as a gas turbine. In some aspects, a working fluid environment can correspond to an engine. In some aspects, a working fluid environment can correspond to a machine environment.

In this discussion, references to a surface being “transparent” are understood to correspond to a surface that is at least partially transparent relative to transmission of light from a light source to trigger fluorescence as well as transmission of light generated by fluorescence. This can typically correspond to a surface being at least partially transparent to ultraviolet wavelengths, visible wavelengths, infrared wavelengths, or a combination thereof. For example, when a ultraviolet light source is used to induce fluorescence in a marker that generates visible fluorescence, a suitable transparent surface can be at least partially transparent for ultraviolet and visible wavelengths.

In this discussion, a light source or a light collector can be referred to as being “optically aligned” with a surface. A light collector that is optically aligned with a surface is defined as a light collector that is position to directly receive (collect) light that is transmitted through the surface without requiring reflection of the light off of another surface. In other words, at least some optical paths are present from the transmitting surface to the light collector without contacting another surface. It is noted that any internal reflections in the transmitting surface are not considered in determining a direct optical path. Similarly, a light source that is optically aligned with a surface is defined as a light source that is position to directly transmit light through the surface without requiring reflection of the light off of another surface.

In this discussion, ultraviolet wavelengths are defined as wavelengths from 10 nm to 390 nm, visible wavelengths are defined as wavelengths from 390 nm to 700 nm, and infrared wavelengths are defined as wavelengths from 700 nm to 1000 nm.

### Light Source and Fluorescence Detector

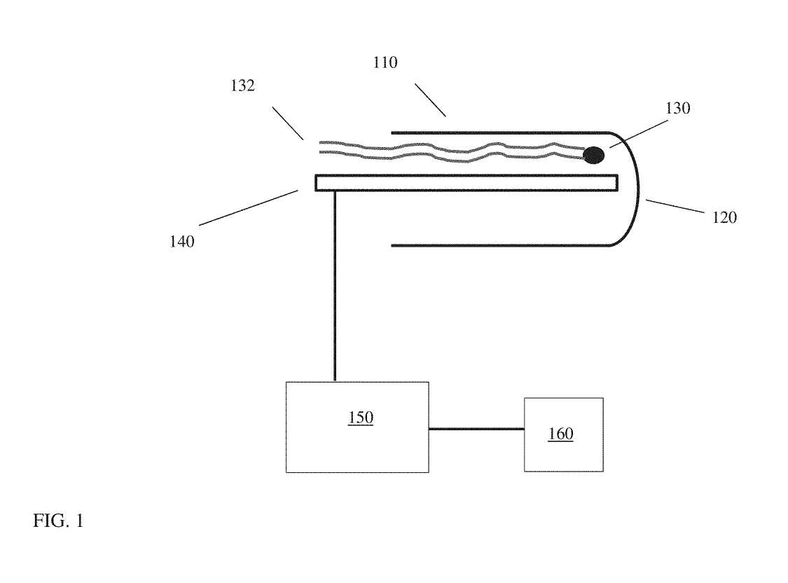

FIG. 1 shows an example of a fluorescent backscatter detector suitable for use in characterizing a working fluid. In FIG. 1, housing 110 corresponds to an enclosure that can optionally protrude into an environment containing a working fluid. At least a portion of housing 110 can correspond to a transparent surface, such as transparent end 120 shown in FIG. 1. Examples of suitable materials for a housing can include, but are not limited to, glass, plexiglass, and/or other plastic. Another option can be to have a metal housing with an end portion composed of glass, plastic, or crystal.

The housing can be inserted into a working fluid environment either as a temporary probe using an existing opening, or as a permanent portion of the enclosure for the working fluid, such as by welding or screwing the housing in place. The housing can be inserted in any convenient location where working fluid is present in the working fluid environment. Examples of suitable locations for insertion of a housing containing a fluorescent backscattering system can include, but are not limited to, a flow stream or fluid line (such as a pipe or conduit); a sump; a day tank; or any other location where working fluid is present in a machine. The internal volume of the housing can be sealed off relative to the volume containing the working fluid, so that the working fluid does not enter the housing volume.

Although housing 110 is shown as a unified housing containing both a light transmission source and a detector, it is understood that separate housings could be used to contain the light transmission source and light collector, respectively. In such an aspect, the separate housings can be located in close proximity to one another to allow for detection of fluorescent while reducing or minimizing transmission of fluoresced light through the working fluid. The distance between such separate housings can be on the order of 1.0 cm or less.

In the example configuration shown in FIG. 1, housing 110 can include a light source 130, a light collector such as a fiber optic structure 140, and a sensor 150. The light source 130 and the fiber optic structure 140 can be mounted within the internal volume of housing 110. The light source 130 can include electrical leads 132 for providing power to the light source. The fiber optic structure 140 can pass the received light into sensor 150. In some alternative aspects, sensor 150 can be mounted within the housing 110, with the light collector being optional and/or corresponding to the sensor itself.

The light source can correspond to a light source suitable for emitting light to excite a desired fluorescence transition in a marker added to the working fluid. Additionally or alternately, in aspects where it is desired to determine an age of the working fluid, the light source can be suitable for exciting a fluorescence transition in the working fluid itself. Suitable light sources can correspond to ultraviolet sources, visible sources, infrared sources, or a combination thereof.

A light collector can correspond to a fiber optic cable or or other fiber optic structure suitable for receiving the fluorescent light emitted from the working fluid and/or the marker in the working fluid. Alternatively, a sensor with a light receiving surface may be directly included into/mounted in the housing. The backscattered light received by the fiber optic can be carried to the sensor for determination of the wavelength(s) of received light. The received wavelength(s) of light can then be compared with one or more reference values, such as reference colors. The comparison can be performed, for example, by an additional processing unit that is in communication with or associated with the sensor. The comparison with the reference values can be used, for example, to determine if the marker is present or absent. Additionally or alternately, at least a portion of the reference values can correspond to reference wavelengths and/or reference colors that correspond to various aging/degradation states of the working fluid. In such additional or alternate aspects, the comparison with the reference values can be used, for example, to determine an age or degradation stage for the working fluid. Optionally, a remaining useful age for the working fluid can be determined and displayed to an operator of the working fluid environment.

In aspects where an additional processing unit 160 is present to perform additional manipulation of values generated by sensor 150 and/or to compare generated values with reference values, the processing unit can correspond to any convenient type of processing unit. Optionally, the processing unit can be part of sensor 150. The processing unit 160 can communicate with sensor 150 by any convenient method, including but not limited to, wired electrical communication, Bluetooth communication, Wi-Fi communication, or any other convenient method of wireless communication. The processing unit 160 can allow for computations that are carried out by hardware, firmware, and/or software. For instance, various functions may be carried out by one or more processors executing instructions (such as program modules) stored in an associated memory. Generally, program modules including routines, programs, objects, components, data structures, etc. refer to code that perform particular tasks or implement particular abstract data types. The invention may be practiced in any convenient computing environment, such as a stand-alone computing environment, a hand-held computing environment, and/or a distributed computing environment where tasks are performed by remote-processing devices that are linked through a communications network.

A processing unit, processor, and/or other computing environment can generally include a variety of computer-readable media. Computer-readable media can be any available media that can be accessed by computing device and includes both volatile and nonvolatile media, removable and non-removable media. In some aspects, the computer-readable media can include volatile and nonvolatile, removable and non-removable media implemented in any method or technology for storage of information such as computer-readable instructions, data structures, program modules or other data. For example, computer-readable media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device. Additionally or alternately, computer-readable media can correspond to non-transitory computer-readable media and/or can correspond to media that excludes signals per se. Memory includes computer storage media in the form of volatile and/or nonvolatile memory. The memory may be removable, non-removable, or a combination thereof. Exemplary hardware devices include solid-state memory, hard drives, optical-disc drives, etc.

### Example 1—Backscatter Detection of Fluorescent Dye in Working Fluid

Fluorescent backscattering from a working fluid was performed using a red-green-blue (RGB) sensor. The RGB sensor was attached to a fiber optic cable that was used to collect the fluorescent light. The RGB sensor generated three intensity values as output corresponding to average intensities for the red, green, and blue channels. The end of the fiber optic cable was included in a housing along with an ultraviolet light source that was used as the light source for triggering fluorescence. The housing was a glass tube that was inserted into a working fluid environment so that the working fluid surrounded the glass tube.

After receiving the red, green, and blue intensity values, the values were combined using a functional form corresponding to xG²/yR*zB to provide a single characteristic value, where x, y, and z were constants and G, R, and B corresponded to measured intensity values from the RGB detector. The characteristic value was then used to determine whether a marker dye was present or absent in the working fluid.

In this example, the working fluid corresponded to a lubricating oil (engine oil) of typical lubricating viscosity for an engine. The lubricating oil was placed in a test environment that allowed for circulation of the lubricating oil. The lubricating oil was a mixture of fresh lubricating oil that also included 5 wt % of a used lubricating oil, in order to represent an aged working fluid. Fluorescent backscattering was performed without the lubricating oil being present, with the lubricating oil present but without a marker dye, and with 30 wppm of a marker dye included in the lubricating oil.

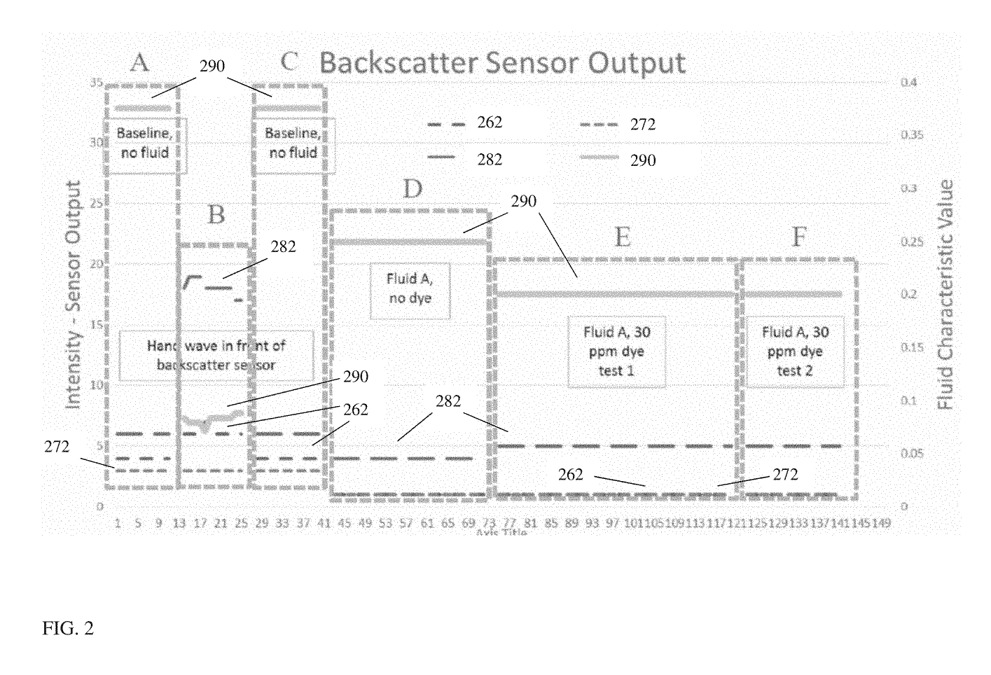

FIG. 2 shows results from detection of the backscattered fluorescent light. FIG. 2 shows the intensities of the red, green, and blue channels from the RGB sensor during detection. The red channel corresponds to lines 262, the green channel corresponds to lines 272, and the blue channel corresponds to lines 282. FIG. 2 also shows the characteristic value 290 determined based on the mathematical combination of the channels. In FIG. 2, measurement zone A corresponds to measurements made in the absence of a lubricating oil in the chamber. As a result, the color values detected by the sensor are related to the light emitted from the UV light source. As would be expected, the UV light source showed a substantially higher intensity from the blue channel than the red or the green channel.

Measurement zone B corresponds to measurement when the operator's hand was passed between the UV light source and the opposite wall of the test chamber. This changed the light reflected back into the sensor, and resulted in corresponding changes in the red, green, and blue channels. Measurement zone C shows that the sensor provided the same values as measurement zone A when the operator's hand was removed.

After the initial tests to verify basic operation, a lubricating oil was introduced into the test apparatus as a working fluid. The lubricating oil corresponded to primarily fresh oil with 5 wt % of used oil to represent a partially aged working fluid. Measurement zone D shows the measured color channel values and the characteristic value based on introduction of the lubricating oil. It is noted that the lubricating oil in measurement zone D did not include a fluorescent dye or marker.

After a period of time, 30 wppm of a commercially available fluorescent dye was added to the lubricating oil. As shown in measurement zone E, addition of the fluorescent dye modified the intensity of the signal detected by the blue channel of the RGB sensor. The intensity change is sufficient to clearly distinguish versus measurement zone D where the fluorescent marker was not present. This results in a change in the characteristic value as well. For the example shown in FIG. 2, the characteristic value for measurement zone E corresponds to a reference value that indicates the presence of a marker dye in a lubricating oil. After a period of time, the chamber was emptied, and then the lubricant oil plus 30 wppm of marker was introduced again. Measurement zone F shows that the same characteristic value as measurement zone E was produced.

### Comparative Example 2—Attempt to Detect Fluorescent Dye Via Transmission

In this comparative example, a working fluid and fluorescent dye similar to Example 1 were used. However, the light source and the RGB (fluorescence) detector were arranged in a conventional transmission geometry. Thus, for fluorescent light to reach the detector, some combination of the incident light from the light source and the resulting fluorescence from the fluorescent dye would need to travel through the full width of the fluid. In this configuration, the working fluid was passed through a small channel. The receiving surface for the optical detector was pointed at the working fluid on one side of the channel, with the light source on the opposite side of the working fluid. The width of the working fluid at the location where the optical detector and the light source opposed each other was approximately 1 cm. The working fluids were the same as the working fluids used in FIG. 2. Thus, the initial working fluid corresponded to an engine oil that included 5 wt % of used oil. The working fluid was then changed to include 30 wppm of the commercially available fluorescent dye.

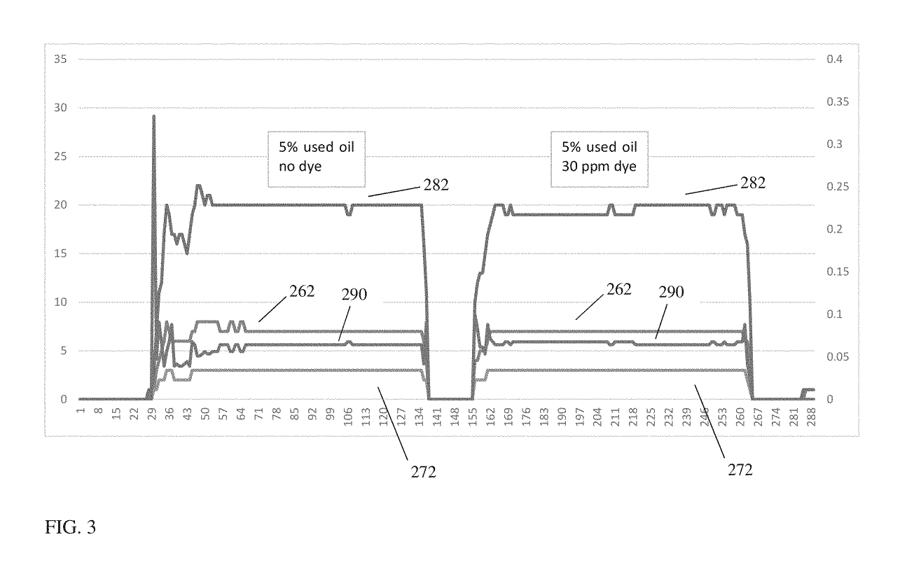

FIG. 3 shows the RGB results and the characteristic values calculated based on the detected RGB values. In the first portion of FIG. 3, no dye is included in the working fluid. This results in the red (262), green (272), and blue (282) values shown in FIG. 3, along with a characteristic value (290) calculated in the same manner as FIG. 2. Detection was then paused while the working fluid was changed to include the 30 wppm of the commercially available fluorescent dye. As shown in FIG. 3, inclusion of the fluorescent dye resulted in no change in the characteristic value 290 or in any of the individual color channels 262, 272, or 282. This demonstrates that backscatter fluorescence was suitable for characterizing a working fluid that could not readily be characterized using fluorescence in a conventional transmission configuration.

### Additional Embodiments

### Embodiment 1

A fluorescent backscattering system, comprising: a housing comprising a housing volume, the housing volume comprising a first surface that is at least partially transparent to a first set of wavelengths and a second surface that is at least partially transparent to a second set of wavelengths; a light source within the housing volume, the light source being capable of generating light comprising at least one wavelength of the first set of wavelengths; a light collector within the housing volume, the light collector comprising a receiving surface, the receiving surface being optically aligned with the second surface; and a sensor for receiving light collected by the light collector, wherein the first surface and the second surface are the same, or wherein the first surface and the second surface are separated by 1.0 cm or less.

### Embodiment 2

The system of Embodiment 1, further comprising a volume of a working fluid environment, the housing being mounted as part of a surface of the volume of the working fluid environment.

### Embodiment 3

The system of any of the above embodiments, wherein the system further comprises a processor and associated memory for storing computer-executable instructions that, when executed, provide a signal analyzer for receiving one or more values from the sensor and performing a comparison based on the received values with at least one reference value.

### Embodiment 4

The system of any of the above embodiments, wherein the light source is mounted within the housing volume, or wherein the light collector is mounted within the housing volume, or a combination thereof.

### Embodiment 5

A method for characterizing a working fluid using fluorescent backscattering, comprising: passing a working fluid optionally comprising 1 wppm to 1000 wppm (or 1 wppm to 100 wppm, or 5 wppm to 30 wppm) of a fluorescent marker through a volume of a working fluid environment, the volume of the working fluid environment comprising a first surface that is at least partially transparent to a first set of wavelengths and a second surface that is at least partially transparent to a second set of wavelengths, at least one of the working fluid and the fluorescent marker comprising a fluorescent transition capable of being excited by one or more wavelengths of the first set of wavelengths and generating fluorescent light comprising at least one wavelength of the second set of wavelengths; generating light comprising at least one wavelength of the first set of wavelengths, at least a portion of the generated light being incident on the first surface; and receiving, through the second surface, fluorescent light generated by the at least one of the working fluid and the fluorescent marker, wherein the first surface and the second surface are the same, or wherein the first surface and the second surface are separated by 1.0 cm or less.

### Embodiment 6

The method of Embodiment 5, wherein the working fluid comprises the fluorescent transition capable of generating fluorescent light comprising the at least one wavelength of the second set of wavelengths, and wherein the fluorescent marker comprises a fluorescent transition capable of being excited by one or more wavelengths of the first set of wavelengths and generating fluorescent light comprising at least one wavelength of a third set of wavelengths, the second surface being at least partially transparent to the third set of wavelengths.

### Embodiment 7

The method of any of Embodiments 5 to 6, the method further comprising characterizing the received fluorescent light by comparing at least one value determined based on the received fluorescent light with a reference value.

### Embodiment 8

The method of any of Embodiments 5 to 7, wherein the volume of the working fluid environment further comprises a housing protruding into the volume of the working fluid environment, the housing comprising a housing volume and at least one of the first surface and the second surface.

### Embodiment 9

The method of Embodiment 8, wherein the housing volume comprises a light source, and wherein generating light comprising at least one wavelength of the one or more wavelengths comprises generating light using the light source.

### Embodiment 10

The method of Embodiment 8 or 9, wherein the housing volume comprises a fiber optic collector, and wherein receiving fluorescent light generated by the at least one of the working fluid and the fluorescent marker comprises receiving fluorescent light by the fiber optic collector.

### Embodiment 11

The method of Embodiment 10, wherein the fiber optic collector passes the received fluorescent light to a sensor, the sensor generating one or more intensity values based on the received fluorescent light, the method further comprising characterizing the received fluorescent light by i) comparing the generated one or more intensity values with one or more reference values, ii) calculating a characteristic value based on the generated one or more intensity values and comparing the characteristic value with a reference value, or iii) a combination of i) and ii).

### Embodiment 12

The method of any of Embodiments 5-11, wherein the working fluid comprises 0.1 vol % to 7.0 vol % of soot, particles, debris, or a combination thereof (or 0.1 vol % to 6.0 vol %); or wherein the working fluid comprises a lubricating oil, a hydraulic fluid, a brake fluid, a fuel, a grease, a transmission oil, an engine oil, a gear oil, or a combination thereof; or a combination thereof.

### Embodiment 13

The system or method of any of the above embodiments, wherein the sensor comprises an RGB color sensor; or wherein the light source comprises at least one of an ultraviolet light source, a visible light source, and an infrared light source; or a combination thereof.

### Embodiment 14

The system or method of any of the above embodiments, wherein the sensor comprises the receiving surface, or wherein the light collector comprises a fiber optic collector in communication with the sensor, the fiber optic collector comprising the receiving surface, the fiber optic collector optionally comprising a fiber optic cable.

### Embodiment 15

The system or method of any of the above embodiments, wherein at least one of the first set of wavelengths and the second set of wavelengths comprise ultraviolet wavelengths, visible wavelengths, infrared wavelengths, or a combination thereof; or wherein the first set of wavelengths comprise ultraviolet wavelengths and the second set of wavelengths comprise visible wavelengths.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A fluorescent backscattering system, comprising:
a housing comprising a housing volume, the housing volume comprising a first surface that is at least partially transparent to a first set of wavelengths and a second surface that is at least partially transparent to a second set of wavelengths;
a light source within the housing volume, the light source being capable of generating light comprising at least one wavelength of the first set of wavelengths;
a light collector within the housing volume, the light collector comprising a receiving surface, the receiving surface being optically aligned with the second surface; and
a sensor for receiving light collected by the light collector,
wherein the first surface and the second surface are the same, or wherein the first surface and the second surface are separated by 1.0 cm or less.

2. The system of claim 1, wherein the sensor comprises an RGB color sensor.

3. The system of claim 1, wherein the sensor comprises the receiving surface.

4. The system of claim 1, wherein the light collector comprises a fiber optic collector in communication with the sensor, the fiber optic collector comprising the receiving surface, the fiber optic collector optionally comprising a fiber optic cable.

5. The system of claim 1, further comprising a volume of a working fluid environment, the housing being mounted as part of a surface of the volume of the working fluid environment.

6. The system of claim 1, wherein the light source comprises an ultraviolet light source, a visible light source, an infrared light source, or a combination thereof.

7. The system of claim 1, wherein at least one of the first set of wavelengths and the second set of wavelengths comprise ultraviolet wavelengths, visible wavelengths, infrared wavelengths, or a combination thereof.

8. The system of claim 1, wherein the first set of wavelengths comprise ultraviolet wavelengths and the second set of wavelengths comprise visible wavelengths.

9. The system of claim 1, wherein the light source is mounted within the housing volume, or wherein the light collector is mounted within the housing volume, or a combination thereof.

10. The system of claim 1, wherein the system further comprises a processor and associated memory for storing computer-executable instructions that, when executed, provide a signal analyzer for receiving one or more values from the sensor and performing a comparison based on the received values with at least one reference value.

11. A method for characterizing a working fluid using fluorescent backscattering, comprising:
passing a working fluid through a volume of a working fluid environment, the working fluid optionally comprising 1 wppm to 1000 wppm of a fluorescent marker, the volume of the working fluid environment comprising a first surface that is at least partially transparent to a first set of wavelengths and a second surface that is at least partially transparent to a second set of wavelengths, at least one of the working fluid and the fluorescent marker comprising a fluorescent transition capable of being excited by one or more wavelengths of the first set of wavelengths and generating fluorescent light comprising at least one wavelength of the second set of wavelengths;
generating light comprising at least one wavelength of the one or more wavelengths, at least a portion of the generated light being incident on the first surface; and
receiving, through the second surface, fluorescent light generated by the fluorescent marker,
wherein the first surface and the second surface are the same, or wherein the first surface and the second surface are separated by 1.0 cm or less.

12. The method of claim 11, wherein the working fluid comprises the fluorescent transition capable of generating fluorescent light comprising at least one wavelength of the second set of wavelengths, and wherein the fluorescent marker comprises a fluorescent transition capable of being excited by one or more wavelengths of the first set of wavelengths and generating fluorescent light comprising at least one wavelength of a third set of wavelengths, the second surface being at least partially transparent to the third set of wavelengths.

13. The method of claim 11, the method further comprising characterizing the received fluorescent light by comparing at least one value determined based on the received fluorescent light with a reference value.

14. The method of claim 11, wherein the volume of the working fluid environment further comprises a housing protruding into the volume of the working fluid environment, the housing comprising a housing volume and at least one of the first surface and the second surface.

15. The method of claim 14, wherein the housing volume comprises a light source, and wherein generating light comprising at least one wavelength of the one or more wavelengths comprises generating light using the light source.

16. The method of claim 15, wherein the light source comprises an ultraviolet light source, a visible light source, an infrared light source, or a combination thereof.

17. The method of claim 14, wherein the housing volume comprises a fiber optic collector, and wherein receiving fluorescent light generated by the at least one of the working fluid and the fluorescent marker comprises receiving fluorescent light by the fiber optic collector.

18. The method of claim 17, wherein the fiber optic collector passes the received fluorescent light to a sensor, the sensor generating one or more intensity values based on the received fluorescent light, the method further comprising characterizing the received fluorescent light by i) comparing the generated one or more intensity values with one or more reference values, ii) calculating a characteristic value based on the generated one or more intensity values and comparing the characteristic value with a reference value, or iii) a combination of i) and ii).

19. The method of claim 11, wherein the working fluid comprises 0.1 vol % to 7.0 vol % of soot, particles, debris, or a combination thereof.

20. The method of claim 11, wherein the working fluid comprises a lubricating oil, a hydraulic fluid, a brake fluid, a fuel, a grease, a transmission oil, an engine oil, a gear oil, or a combination thereof.
